(19) United States
(12) Patent Application Publication
(10) Pub. No.: US 2017/0228747 A1
(43) Pub. Date: Aug. 10, 2017

(54) PROCESS FOR MONITORING THE AUDIENCE IN A TARGETED REGION

(71) Applicant: QUIVIDI, Paris (FR)

(72) Inventors: Paolo Prandoni, Paris (FR); Olivier Duizabo, Paris (FR); Ke-Quang Nguyen-Phuc, Paris (FR)

(21) Appl. No.: 15/329,505

(22) PCT Filed: Aug. 4, 2014
(86) PCT No.: PCT/EP2014/066745

§ 371 Date: Jan. 26, 2017

(51) Int. Cl. G06Q 30/02; G06T 7/11; H04N 7/18; G06F 17/30; G06F 21/62

(52) U.S. Cl. CPC G06Q 30/0205; G06F 17/3028; G06F 21/6245; G06Q 30/0251; H04N 7/183; G06T 7/11; G06T 2207/30204

(57) ABSTRACT

Process for monitoring the audience in a targeted region, the process providing for capturing at least one image of at least one person located in the targeted region, analyzing the image for determining at least one information about the person, registering the determined information in an audience database, and the process further providing for identifying the eventual presence of an exclusion tag related to the person, so as to provide an exclusion mark for the monitoring of the person in the case of such a presence.

### CROSS-REFERENCE TO RELATED APPLICATION

The present application is the US national phase of International Patent Application Nol. PCT/EP2014/066745, filed Aug. 4, 2014. The entirety of PCT/EP2014/066745 is incorporated herein by reference.

### FIELD OF THE DISCLOSURE

The invention relates to a process for monitoring the audience in a targeted region, such as a system for implementing such a process.

### BACKGROUND

The invention applies in particular to the monitoring of the audience located in the vicinity of a point of interest, such as a signage installation, a display, a physical product, a showcase or a screen, especially the audience watching an advertising message on said point of interest, or to the monitoring of the audience which circulates in a particular region, such as for example inside a store, a boutique, an agency, a lounge, a restaurant, a mall or a transportation hub.

In the domain of advertising, it is important to identify precisely the potential customers and their habits, so as to maximize the impact of an advertising campaign.

In particular, as the use in public areas of advertising installations with digital display devices, as for example digital flat screens and digital billboards, is more and more frequent, it is interesting to monitor the whole audience circulating in the vicinity of such installations, so as to better adapt the advertising spots to display on said installations according to the results of said monitoring.

To do so, document WO-2007/120686 describes a process for monitoring the audience in a targeted region, notably the audience located in the vicinity of an advertising display installation, said process providing for:

capturing at least one image of at least one person located in said region, notably by means of a camera installed in the vicinity of said region;

analysing said image for determining at least one information about said person;

registering said determined information in an audience database, notably for a subsequent use in view of statistical analysis or of the accurate selection of an advertising message to be displayed on the installation.

In particular, this document provides for analysing the captured images with high level image processing algorithms, such as notably face detection or face recognition algorithms, so as to obtain very precise information about the audience.

For example, face detection or face recognition algorithms allows for obtaining easily information about physical attributes of a person, such as information relating to the age, the gender, the ethnic group, the lifestyle and/or the dress style of said person, such information being very useful for identifying the average profile of the audience interested in an advertising message, and thus for accurately selecting an advertising message to be displayed on an installation according to the audience standing in front of said installation.

However, this solution is not entirely satisfactory, as it cannot allow to select accurately the audience to be monitored. Indeed, when the targeted region is localised in a public venue, such as for example in a store, this solution monitors all the people circulating in said region, including the employees of said public venue, although they do not really represent an interesting target for market research.

Moreover, this solution, even if it is performed anonymously, may incommode people who do not want to be monitored, notably for protecting their privacy.

### SUMMARY OF THE DISCLOSURE

The invention aims to improve the prior art by proposing a solution for performing an audience monitoring in a targeted region, said solution allowing to monitor more accurately people circulating in said region, and thus to obtain more accurate results about the average profile of the audience and the potential audience of advertising messages.

For that purpose, and according to a first aspect, the invention relates to a process for monitoring the audience in a targeted region, said process providing for:

capturing at least one image of at least one person located in said region;

analysing said image for determining at least one information about said person;

registering said determined information in an audience database;

said process further providing for identifying the eventual presence of an exclusion tag related to said person, so as to provide an exclusion mark for the monitoring of said person in the case of such a presence.

According to a second aspect, the invention relates to a system for monitoring the audience in a targeted region, said system comprising:

at least one device for capturing at least one image of at least one person located in said region;

at least one determination device comprising means for analysing said image and measuring at least one information about said person;

at least one audience database for registering determined information provided by said determination device;

said system further comprising at least one exclusion device for identifying the eventual presence of an exclusion tag related to said person, said exclusion device comprising means for providing an exclusion mark for the monitoring of said person in the case of such a presence.

Other aspects and advantages of the invention will become apparent in the following description made with reference to the appended figures, which presents a system for audience monitoring according to respectively an embodiment of the invention.

### BRIEF DESCRIPTION OF THE SEVERAL VIEWS OF THE DRAWINGS

FIG. 1 is a flow chart illustrating a first embodiment of the system and process of the present invention; and

FIG. 2 is a flowchart illustrating a variant of the system and process of the present invention.

### DETAILED DESCRIPTION OF THE PREFERRED EMBODIMENTS

In relation to those figures, a process for monitoring the audience in a targeted region, such as a system for implementing such a process, will be described below.

In particular, the targeted region can be localised in a public space, such as in a store, wherein a lot of people, and thus potential audience for advertising messages, can be found. Moreover, the targeted region can comprise a traditional signage installation, such as a display or a poster, or an electronic signage installation, such as a flat screen or a billboard, wherein advertising messages can be displayed to be viewed by people circulating in said targeted region. The process provides for capturing at least one image of at least one person located in the targeted region. To do so, the system comprises at least one device, notably a camera or a video camera, for capturing at least one image of at least one person located in the targeted region.

In particular, when the targeted region comprises an electronic signage installation, the capturing device can be placed in the vicinity of said installation for capturing the scene in front of said installation, wherein people can circulate or even stand for watching messages displayed on said installation.

The process further provides for analysing the captured image for determining at least one information about the person. To do so, the system comprises at least one determination device 1 which comprises means for analysing images provided by the video camera and determining at least one information about a person for which an image is included in the captured images.

In particular, the determination device 1 can comprise means for previously processing the image captured by the capturing device, so as to detect in said captured image an image of a person, such as means for further analysing said detected image of said person and determining at least one information about said person.

The determined information about the person can notably comprise information about at least one physical attribute of said person, such as information about the age, the gender, the ethnic group, the lifestyle, the height and/or the corpulence of said person, but also information about the hairstyle and/or the dressing style of said person.

To do so, the determination device 1 comprises means for determining such physical attribute information. In particular, the determination device 1 can comprise means for implementing specific image processing algorithms to determine information about physical attributes of a person, especially face detection or face recognition algorithms.

The system can also comprise other types of devices, such as for example magnetic meters, pressure sensor mats or infrared sensors, which also capture data about physical attributes of people in the targeted region, such as for example the height and/or the corpulence, and provide said data to the determination device 1, so that said determination device enrich with said data the determined information obtained by analysing images of said persons.

The determined information about the person can also comprise information about the behaviour of said person, as for example the direction of his gaze, which is a good clue for evaluating his interest for an advertising message displayed on a signage installation, or information about his eventual relationships with other people located in the targeted region.

To do so, the determination device 1 can comprise means for measuring information about the direction of the gaze of a person and/or means for measuring information about his eventual relationships with other people for which images has been captured by the video camera, notably by evaluating the distances and/or mutual interactions between said person and said other people. For example, the determination device 1 can implement image processing algorithms adapted for analysing motion patterns of a person and eventual other people located in the targeted region, so as to evaluate such direction of gaze and/or mutual relationships.

The process further provides for registering the determined information in an audience database 2, so as to further exploit said information, as for example for statistical analysis, or for adapting the display of advertising messages on a signage installation, or for other marketing purposes.

To do so, the system comprises at least one audience database 2 for registering determined information provided by the determination device 1, said determination device comprising specific means for doing such a registration.

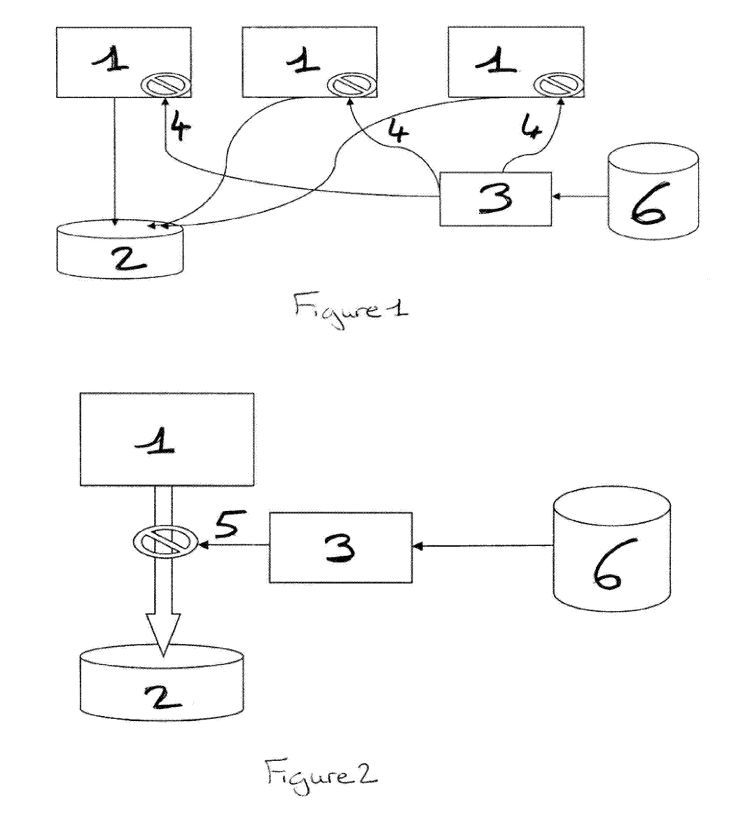

In relation to FIG. 1, the system comprises several determination devices 1 which are located in a same targeted region of a public space and associated with a video camera in said region, each determination device comprising for example means for determining a specific type of information about a person, notably a type of information among the previously cited ones, such as a central audience database 2 wherein all of said determination devices register determined information.

The determined information can also be completed with context based information, such as for example the time and the date at which the image has been captured and the geographical location of the targeted region. Indeed, such context based information are particularly relevant to identify a potential audience, as they allow for example to establish a relationship between typical categories of people and specific geographical locations and day periods, so as to identify the geographical locations and day periods wherein a given category of people is more likely to circulate.

To do so, the system can comprise a clock device adapted for providing the determination device 1 with temporal information about the current date and time, such as a geographical data device adapted for providing said determination device with geographical information about the geographical location of the targeted region, for example a state, a city or a street. If the targeted region is located in a public space, the geographical information can concern the type of said public space, for example a grocery store, an apparel store or a train station, or even the specific location of said region within said space, for example a product aisle (for a store) or a ticket counter (for a transportation hub).

Moreover, the determination device 1 can comprise means for associating determined information about a person with such geographical and temporal information, so as to register said determined information in the audience database along with said associated geographical and temporal information.

For a better and more accurate monitoring of the audience, the process provides for excluding some people of said monitoring, as for example employees of the public space wherein the targeted region is located, because such people do not constitute relevant audience, or more generally all people who do not want to be monitored, notably for privacy reasons.

In particular, the exclusion from the monitoring process may be implemented by default for employees, but it can also be provided as a service to other people, so that people interested in said service may subscribe to benefit from said service and thus protect their privacy.

According to a variant, the monitoring process may be provided itself as a service to people who want to participate, for example for benefiting from particular advantages offered in compensation to subscription to said service. Thus, the monitoring process will monitor only such volunteer persons, and the other person will be excluded by default.

For a person located in a targeted region, the process provides for identifying the eventual presence of an exclusion tag related to said person, so as to provide an exclusion mark for the monitoring of said person in the case of such a presence.

Moreover, the system comprises at least one exclusion device 3 for identifying the eventual presence of such an exclusion tag related to a person, said exclusion device comprising means for providing an exclusion mark for the monitoring of said person in the case of such a presence.

The identification of the eventual presence of an exclusion tag related to a person can be achieved before the analysis of the image of said person.

To do so, in relation to FIG. 1, the exclusion device 3 comprises means adapted for identifying the eventual presence of an exclusion tag related to a person before the analysis by the determination devices 1 of the image of said person.

In particular, as an image is captured, the determination device 1 can at first process said captured image for detecting in said captured image an image of at least one person, and then said determination device can notify the exclusion device 3 upon such a detection, so that said exclusion device will identify the eventual presence of exclusion tag for persons for which images have been detected before the further analysis of said detected images by said determination device.

Thus, if the exclusion device 3 effectively identifies the presence of an exclusion tag related to a person, said exclusion device interacts with the determination device 1, notably by sending a notification 4, to provide to said determination device an exclusion mark for the monitoring of said person.

In particular, the exclusion mark can be used for not performing analysis on the image of the person, and thus for not registering determined information about said person. To do so, the determination device 1 can comprise means for using the exclusion mark provided for the monitoring of a person for not analysing images of said person, and thus for not registering determined information about said person in the audience database 2.

In the same way, if the execution device 3 does not identify the presence of an exclusion tag related to a person, said exclusion device sends a notification to the determination device 1 for allowing said determination device to perform analysis on the image of said person.

The identification of the eventual presence of an exclusion tag related to a person may also be achieved after the analysis of the image of said person.

To do so, in relation to FIG. 2, the exclusion device 3 comprises means adapted for identifying the eventual presence of an exclusion tag related to a person after the analysis by the determination device 1 of the image of said person.

In particular, the determination device 1 can be adapted to interact with the exclusion device 3, notably by sending a notification after achieving the analysis of an image of a person and before registering determined information about said person in the audience database 2.

Thus, as the exclusion device 3 identifies the eventual presence of an exclusion tag related to a person, the exclusion device 3 can, in the case of such a presence, send back to the determination device 1 an exclusion notification 5 for providing to said determination device an exclusion mark for the monitoring of said person.

Otherwise, the exclusion device 3 can send to the determination device 1 a notification for allowing said determination device to register normally said determined information.

In particular, the exclusion mark can be used for not registering determined information about the person. To do so, the determination device 1 can comprise means for using the exclusion mark provided for the monitoring of a person for not registering determined information about said person in the audience database 2.

To process can also provide for registering determined information associated with the exclusion mark in the audience database 2, for example for deleting said determined information later, especially before the further exploitation of all determined information registered in said audience database.

The identification of the eventual presence of an exclusion tag related to a person can notably be achieved by determining a tag of said person, especially by looking for the presence of said tag into an exclusion database 6.

To do so, the system comprises an exclusion database 6, the determination device 1 and/or the exclusion device 3 comprising means for determining a tag of a person, the exclusion device 3 comprising means for looking for the presence of said tag into said exclusion database.

Alternatively, the exclusion device 3 can be adapted to directly identify the presence of an exclusion tag upon the determination of a particular tag for a person and to directly send an exclusion notification 4, 5, and thus without looking for into any exclusion database.

In particular, an exclusion tag related to a person can comprise one of the determined information about said person. To do so, the analysis means of the determination device 1 can be adapted for analysing an image of a person and determine a tag for said person from one of the determined informations about said person. Thus, the determination device 1 can comprise means for providing the exclusion device 3 with the determined tag, and thus before the registration of all of the determined informations about said person into the audience database 2, so that the exclusion device 3 will prevent said registering if needed.

Moreover, the exclusion device 3 can comprise means for identifying as an exclusion tag one of the determined information about the person, especially by using the determined tag of said person provided by the determination device 1.

To do so, the system comprises an exclusion database 6 for storing tags which comprise informations that can be determined upon image analysis, so that people for which such information are determined by the determination device(s) 1 should be excluded from the monitoring process.

Moreover, the exclusion device 3 comprises means for looking for the presence of the determined tag of a person into the exclusion database 6, so as to prevent the registration of determined information about said person in the case of such a presence, and to allow said registration otherwise.

The exclusion tag can notably comprise information related to the physical appearance of a person, especially information about the face of said person. For example, information about the faces of employees can be initially registered as exclusion tags into the exclusion database 6. Thus, as an employee enters the targeted region, the determination device 1 analyses an image of said employee and determines a tag comprising information about his face. Afterwards, the exclusion device 3 verifies the presence of the determined tag into the exclusion database 6 and emits an exclusion notification 5.

The exclusion tag can also be worn by the person. In particular, the exclusion tag can be a distinctive visual marker worn by an employee, such as a piece of uniform or an accessory comprising a logo of the public space wherein the employee works, or more generally an accessory that is provided to people who have subscribed to an exclusion service.

To do so, the determination device 1 can comprise means adapted to analyse an image of a person for detecting the presence of such a visual exclusion marker on said person and thus determining a corresponding tag for said person, such as means for providing the exclusion device 3 with the determined tag, notably before the registration of all of the determined informations about said person into the audience database 2.

Moreover, the exclusion device 3 can comprise means for identifying an exclusion tag from an element worn by the person, especially by using the determined tag of said person provided by the determination device 1.

In particular, the exclusion device 3 can comprise means for looking for the presence of such a determined tag of a person into an exclusion database 6, such as means for sending an exclusion notification 5.

Alternatively, the exclusion tag can come from an electronic device worn by a person.

The electronic device can be notably an electronic chip, such as for example a radio chip, a radiofrequency identification (RFID) chip, an infrared chip or an ultrasound chip, and can also be implemented in a common device to be worn by a person, such as for example a badge to be worn on the clothes of said person. Such as an electronic device can be distributed by default to all employees of a public space and to other people who have subscribed to an exclusion service.

The electronic device can also be a classical mobile device usually worn by people, such as for example a smartphone or a personal digital assistant (PDA).

In that case, the exclusion device 3 can comprises means for identifying an exclusion tag from such an electronic device worn by a person, as for example an identifier of the electronic device of said person.

In particular, the exclusion device 3 can comprise means for extracting the identifier of an electronic device worn by a person, means for determining a tag related to said identifier and means for looking for the presence of said tag into an exclusion database 6 of the system wherein tags related to identifiers of electronic devices of people that should be excluded from the monitoring process are stored.

Thus, the electronic device 3 may send a notification 4, 5 for providing an exclusion mark for the monitoring of a person (FIG. 2) in the case of such a presence.

In particular, the identification of the eventual presence of an exclusion tag can be triggered by detecting a signal emitted by the electronic device, such as for example a radio signal, an infrared signal or an ultrasound signal, depending on the type of said electronic device. To do so, the exclusion device 3 can comprise means for detecting such a signal and for performing such an identification upon such a detection.

The tags can be registered initially into the exclusion database 6, notably for electronic devices that are distributed to people. The tags can also be registered later: for example, a person who subscribes to an exclusion service can register the identifier of his personal mobile terminal into the exclusion database 6 to benefit from said service.

According to a variant, the process can provide for monitoring only volunteer persons, notably persons who have subscribed to a service proposing said process in exchange for benefits for said persons, so that all the other persons will be excluded by default from said process.

To do so, the determined tag of a person can concern the eventual presence of a participation tag for said person, notably related to one of the determined information about said person and/or to an element worn by said person, especially an electronic device worn by said person, so that, upon the absence of a participation tag for a person, the presence of an exclusion tag related to said person will be identified.

In particular, the exclusion database 6 can comprise participation tags that have been registered for volunteer persons, and the exclusion device 3 can comprise means for identifying the eventual presence of an exclusion tag related to a person by checking the eventual absence of a participation tag for said person into said database.

1. A process for monitoring the audience in a targeted region, said process providing for:
capturing at least one image of at least one person located in said region;
analyzing said image for determining at least one information about said person;
registering said determined information in an audience database;
said process further comprising identifying the eventual presence of an exclusion tag related to said person, so as to provide an exclusion mark for the monitoring of said person in the case of such a presence.

2. The process according to claim 1, the identification of the eventual presence of an exclusion tag being achieved before the analysis of the image of the person.

3. The process according to claim 1, the identification of the eventual presence of an exclusion tag being achieved after the analysis of the image of the person.

4. The process according to claim 1, the identification of the eventual presence of an exclusion tag being achieved by determining a tag of the person.

5. The process according to claim 4, the identification of the eventual presence of an exclusion tag being further achieved by looking for the presence of the determined tag into an exclusion database.

6. The process according to claim 4, the determined tag being indicative of the eventual presence of a participation tag for the person, the identification of an exclusion tag related to said person being achieved upon the absence of such a participation tag.

7. The process according to any of claim 1, the exclusion tag comprising one of the determined information about the person.

8. The process according to any of claim 1, the exclusion tag being worn by the person.

9. The process according to claim 8, a source of the exclusion tag being an electronic device worn by the person.

10. The process according to any of claim 1, the exclusion mark being used for not registering determined information about the person.

11. A system for monitoring the audience in a targeted region, said system comprising:
at least one device for capturing at least one image of at least one person located in said region;
at least one determination device comprising means for analyzing said image and determining at least one information about said person;
at least one audience database for registering determined information provided by said determination device;
said system further comprising at least one exclusion device for identifying the eventual presence of an exclusion tag related to said person, said exclusion device comprising means for providing an exclusion mark for the monitoring of said person in the case of such a presence.

12. The system according to claim 11, the exclusion device comprising means adapted for identifying the eventual presence of an exclusion tag related to a person before the analysis by the determination device of the image of said person.

13. The system according to claim 11, the exclusion device comprising means adapted for identifying the eventual presence of an exclusion tag related to a person after the analysis by the determination device of the image of said person.

14. The system according to any of claim 11, the determination device and/or the exclusion device comprises means for determining a tag of a person, the exclusion device further comprising means for identifying the eventual presence of an exclusion tag from said determined tag.

15. The system according to claim 14, further comprising an exclusion database, the exclusion device comprising means for looking for the presence of the determined tag into said exclusion database for identifying the eventual presence of an exclusion tag.

16. The system according to claim 14, the determined tag being indicative of the eventual presence of a participation tag for the person, the exclusion device comprising means for identifying the presence of an exclusion tag related to said person upon the absence of such a participation tag.

17. The system according to any of claim 11, the exclusion device comprising means for identifying as an exclusion tag one of the determined information about the person.

18. The system according to any of claim 11, the exclusion device comprising means for identifying as an exclusion tag an element worn by the person.

19. The system according to claim 18, the exclusion device comprising means for identifying an exclusion tag from an electronic device worn by the person.

20. The system according to claim 11, characterised in that the determination device comprising means for using the exclusion mark for not registering determined information about the person in the audience database.
